(19) United States
(12) Patent Application Publication
(10) Pub. No.: US 2026/0312179 A1
(43) Pub. Date: Oct. 8, 2026

(54) THERMAL SHIELD SYSTEM

(71) Applicant: FCA US LLC, Auburn Hills, MI (US)

(72) Inventors: Harwinder SINGH, Windsor (CA); Subhash S. ODIYAR, Chennai (IN); Dipak MARATHE, Auburn Hills, MI (US)

(21) Appl. No.: 19/171,438

(22) Filed: Apr. 7, 2025

(51) Int. Cl. H01M 10/658; H01M 10/625

(52) U.S. Cl. CPC H01M 10/658; H01M 10/625

(57) ABSTRACT

A thermal shield assembly configured to provide thermal shielding for a vehicle battery. The thermal shield assembly may include a plurality of panels configured to be attached to the vehicle battery and collectively forming a thermal shield, the plurality of panels including a center panel, a first laterally offset panel attached to the center panel, a second laterally offset panel attached to the center panel, a first side panel attached to the first laterally offset panel, and a second side panel attached to the second laterally offset panel, wherein each of the plurality of panels includes a first layer, a second layer, and a third layer, and wherein the first layer and third layer are formed of a rigid metal material and the second layer is formed of an insulative material and is configured to be sandwiched between the first layer and the third layer.

### FIELD

The present disclosure relates to a thermal shield system for a vehicle battery.

### BACKGROUND

This section provides background information related to the present disclosure which is not necessarily prior art.

The popularity of both plug-in hybrid electric vehicles (PHEVs) and electric vehicles (EVs) has grown substantially in recent years. Most PHEVs and EVs utilize lithium-ion or lithium-metal technologies in a battery of the vehicle, and these types of batteries may experience a phenomenon known as thermal runaway events in the case of damage to the battery or malfunction of one of the internal battery cells within the battery.

In a thermal runaway event, one or more of the internal battery cells may fail, which may allow the chemical reaction typically contained within the individual cell to run unmitigated and cause battery temperatures to reach up to 550° C. These high temperatures can damage components of the vehicle located proximate to the battery, which is undesirable. There is a need, therefore, to develop a system that protects both the components surrounding the battery.

### SUMMARY

This section provides a general summary of the disclosure, and is not a comprehensive disclosure of its full scope or all of its features.

According to a first aspect of the present disclosure, there is provided a vehicle that may include a battery including a housing having at least a front housing wall and a pair of side housing walls attached to the front housing wall; and a thermal shield assembly attached to the front housing wall and the pair of side housing walls, wherein the thermal shield assembly is formed of a plurality of panels that are connected to each other, each of the plurality of panels includes a first layer that faces the housing, a second layer attached to the first layer, and a third layer that sandwiches the second layer with the first layer and faces away from the housing, and wherein the thermal shield assembly is configured to insulate the battery, and absorb and reflect heat generated by the battery back toward the battery.

According to the first aspect, the first and third layers are formed of a rigid metal material.

According to the first aspect, the second layer is formed of an insulating material.

According to the first aspect, the first and third layers are formed of aluminum.

According to the first aspect, the second layer includes fiberglass.

According to the first aspect, the first and third layers have a thickness that ranges between 0.5 to 1.0 mm.

According to the first aspect, the second layer has a thickness that ranges between 1.0 to 2.5 mm.

According to the first aspect, the plurality of panels includes a center panel, a first laterally offset panel attached to the center panel, a second laterally offset panel attached to the center panel, a first side panel attached to the first laterally offset panel, and a second side panel attached to the second laterally offset panel.

According to a second aspect of the present disclosure, there is provided a thermal shield assembly configured to provide thermal shielding for a vehicle battery. The thermal shield assembly may include a plurality of panels configured to be attached to the vehicle battery and collectively forming a thermal shield, the plurality of panels including a center panel, a first laterally offset panel attached to the center panel, a second laterally offset panel attached to the center panel, a first side panel attached to the first laterally offset panel, and a second side panel attached to the second laterally offset panel, wherein each of the plurality of panels includes a first layer, a second layer, and a third layer, and wherein the first layer and third layer are formed of a rigid metal material and the second layer is formed of an insulative material and is configured to be sandwiched between the first layer and the third layer.

According to the second aspect, the vehicle battery includes a housing having at least a front housing wall and a pair of side housing walls attached to the front housing wall, each of the center panel, the first laterally offset panel, and the second laterally offset panel are configured to be attached to the front housing wall, and the first side panel and the second side panel are configured to be attached to a respective side housing wall.

According to the second aspect, the thermal shield is configured to insulate the vehicle battery and absorb and reflect heat generated by the battery back toward the battery.

According to the second aspect, the first layer is configured to face the housing.

According to the second aspect, the first layer and the third layer are formed of aluminum.

According to the second aspect, the first layer and the third layer each have a thickness that ranges between 0.5 to 1.0 mm.

According to the second aspect, the second layer includes fiberglass.

According to the second aspect, the second layer has a thickness that ranges between 1.0 to 2.5 mm.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic illustration of an example vehicle having a battery according to a principle of the present disclosure;

FIG. 2 is a perspective view of an example battery that may be used in the vehicle illustrated in FIG. 1, including a thermal shield assembly according to a principle of the present disclosure;

FIG. 3 is an exploded perspective view of the thermal shield illustrated assembly in FIG. 2;

FIG. 4 is a perspective view of one of the panels of the thermal shield assembly, which additionally illustrates that the panels may be formed of multiple layers according to a principle of the present disclosure; and

FIG. 5 is an exploded perspective view of the panel illustrated in FIG. 4.

Corresponding reference numerals indicate corresponding parts throughout the several views of the drawings.

### DETAILED DESCRIPTION

Example embodiments will now be described more fully with reference to the accompanying drawings.

Example embodiments will now be described more fully with reference to the accompanying drawings. The example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

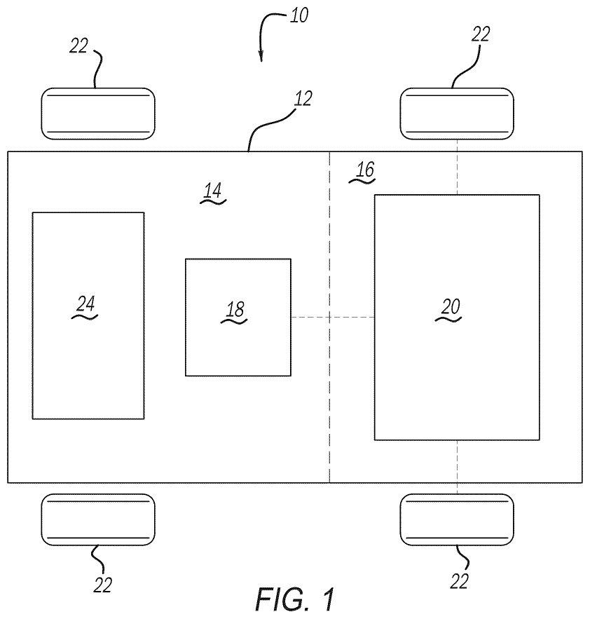

FIG. 1 schematically illustrates an example vehicle 10 according to the present disclosure. Vehicle 10 includes a body 12, which may be divided into an engine compartment 14 and a passenger compartment 16. Vehicle 10 may be an electrically-powered vehicle 10 having a battery 18 in communication with an electric drive module 20 that can be used to provide power to at least one of the wheels 22 of vehicle 10. In the illustrated embodiment, electric drive module 20 may provide power to the rear wheels 22, but it should be understood that electric drive module 20 can be positioned proximate the front wheels 22, or each wheel 22 can be provided with a dedicated electric drive module 20 without departing from the scope of the present disclosure.

In addition to the battery 18 being connected to and providing power to the electric drive module 20, the battery 18 may be used to provide power to other vehicle systems (e.g., vehicle lighting, HVAC, and the like) as is known in the art. While battery 18 is illustrated as being located in engine compartment 14, it should be understood that battery 18 is typically positioned beneath a floor (not shown) of vehicle 10 and may overlap each of the engine compartment 14 and the passenger compartment 16.

Vehicle 10 may optionally include an internal combustion engine 24 such that vehicle 10 can operate as a plug-in electric hybrid vehicle (PHEV), if desired.

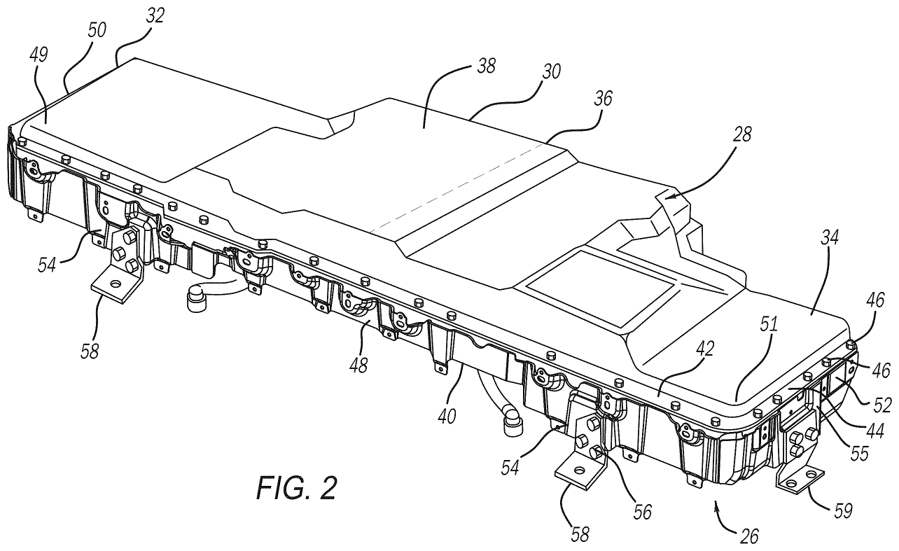

Turning now to FIG. 2, an example battery 18 that includes a thermal shield assembly 26 according to the present disclosure is illustrated. Battery 18 includes a housing 28, which is configured to encase a number of individual battery cells (not shown). Housing 28 may be formed of a rigid metal material such as aluminum, but may also be formed of a structurally rigid polymeric material if desired. The primary aspect to keep in mind is that housing 28 is formed of a rigid material that is resistant to puncture.

In the illustrated embodiment, housing 28 may be generally T-shaped, having a truncated rear portion 30 and two laterally extending wings 32, 34, which are generally equidistant relative to a central plane 36 of the housing 28. It should be understood, however, that housing 28 can have alternative configurations if desired to account for packing restrictions on vehicle 10. In any event, housing 28 may include a top housing portion or lid 38 and a bottom housing portion or tray 40. Top housing portion 38 and bottom housing portion 40 come together to form a seam 42 extending around a perimeter 44 of housing 28, and may be secured together with a series of fasteners 46 such as screws or bolts. Bottom housing portion 40 further includes a generally vertical front surface 48 and side surfaces 50, 52, as well as two corners 49, 51, which form a transition between the vertical front surface 48 and the side surfaces 50, 52, at the end of each wing 32, 34, respectively.

With continued reference to FIG. 2, thermal shield assembly 26 is configured to wrap around and be affixed to both the front surface 48 and side surfaces 50, 52 of housing 28. Thermal shield assembly 26 is shaped to generally conform to the underlying geometry of housing 28, which allows the shield assembly 26 to adequately deflect heat and prevent high temperatures from reaching various components of vehicle 10 located proximate to battery 18 and the passenger cabin 16 during a thermal runaway event.

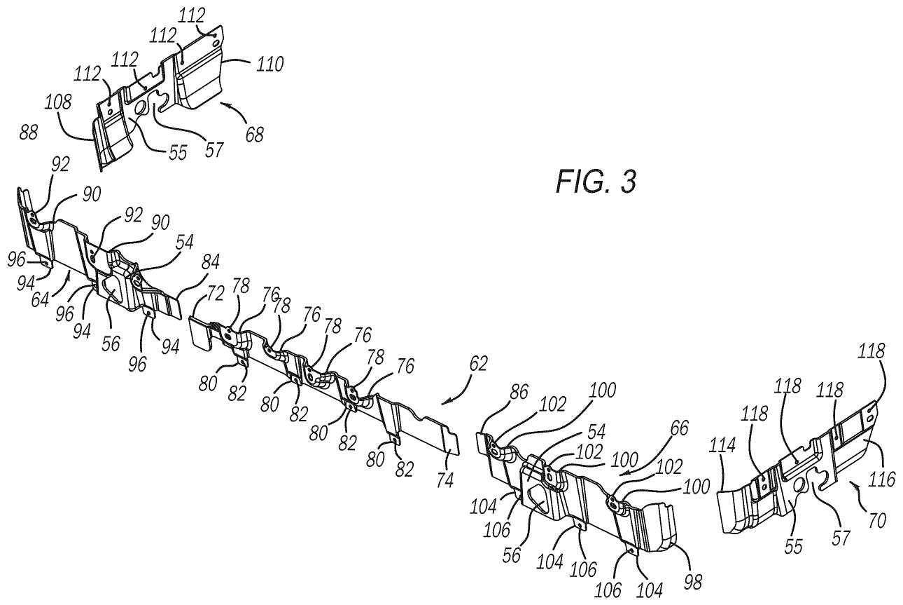

As best shown in FIG. 3, thermal shield assembly 26 may be formed of a plurality of panels including a center panel 62, a first laterally offset panel 64, a second laterally offset panel 66, a first side panel 68, and a second side panel 70, which enables the shield assembly 26 to be disassembled and reassembled as needed for shipping and attachment to battery 18. While thermal shield assembly 26 preferably is formed of a plurality of panels 62-70, it should be understood that thermal shield assembly 26 may be a monolithic member without departing from the scope of the present disclosure.

As noted above, shield assembly 26 is shaped to generally conform to the underlying geometry of housing 28 of battery 18. Panels 62-70, therefore, may include various notches 54 and 55 and apertures 56 and 57 that are configured to accommodate and provide access to various brackets 58 and 59 of housing 28.

Still referring to FIG. 3, center panel 62 extends laterally across front surface 48 of housing 28 and includes a first center end 72 and a second center end 74. An upper edge of center panel 62 may include a plurality of protrusions 76 having apertures 78 configured to accommodate the underlying housing 28 geometry and to allow the center panel 62 to be affixed to adjacent trim components (e.g., brackets-not shown) that are attached to a floor or frame (not shown) of vehicle 10. Center panel 62 additionally includes a plurality of tabs 80 and apertures 82 configured to allow the center panel 62 to be secured to the vertical front surface 48 of housing 28. First center end 72 of the center panel 62 is configured to overlap the first lateral offset panel 64 at a first offset proximal end 84. Second center end 74 of the center panel 62 is configured to overlap a second offset proximal end 86 of the second lateral offset panel 66.

With continuing reference to FIG. 3, first lateral offset panel 64 extends between first offset proximal end 84 to a first cornered end 88 and includes a pair of protrusions 90 having apertures 92, which allow the first lateral offset panel to be affixed to various trim components of the floor or frame (not shown) of the vehicle 10. First lateral offset portion 64 additionally includes a plurality of tabs 94 and apertures 96, which permit the first lateral offset panel 64 to be affixed to the housing 28 along the vertical front surface 48 of wing 32. Similarly, the second lateral offset portion 66 extends between a second offset proximal end 86 to a second cornered end 98, and includes a plurality of protrusions 100 having apertures 102 which permit the second lateral offset portion 66 to be affixed to various trim components of the floor or frame (not shown) of the vehicle 10. The second lateral offset portion 66 additionally includes a plurality of tabs 104 having apertures 106 which permit the second lateral offset portion 66 to be affixed to the housing 28 along the vertical front surface 48 of wing 34. Both the first lateral offset portion 64 and second lateral offset portion 66 include one of front notches 54 and front apertures 56 which are configured to accommodate front brackets 58, such that housing 28 may be affixed to the floor or frame (not shown) of vehicle 10.

Still referring to FIG. 3, first side panel 68 extends between a first proximal side end 108 to a first distal side end 110, and includes one of side notch 55 and aperture 57 in order to accommodate a bracket 58 for securing the housing 28 to the vehicle 10. First side panel 68 additionally includes a plurality of apertures 112 with which the first side portion 68 may be affixed to the housing 28 along side surface 50. Similarly, second side panel 70 extends between a second proximal side end 114 to a second distal end 116, and also includes one of notch 55 and aperture 57, for accommodating a bracket 58. Second side panel 70 additionally includes apertures 118 to allow the second side panel 70 to be affixed to the side surface 52 of housing 28. When assembled, first cornered end 88 is configured to overlap the first proximal side end 108 at corner 49 between the vertical front surface 48 and the side surface 50. Similarly, second cornered end 98 is configured to overlap the second proximal side end 114 at corner 51 between the vertical front surface 48 and side surface 52.

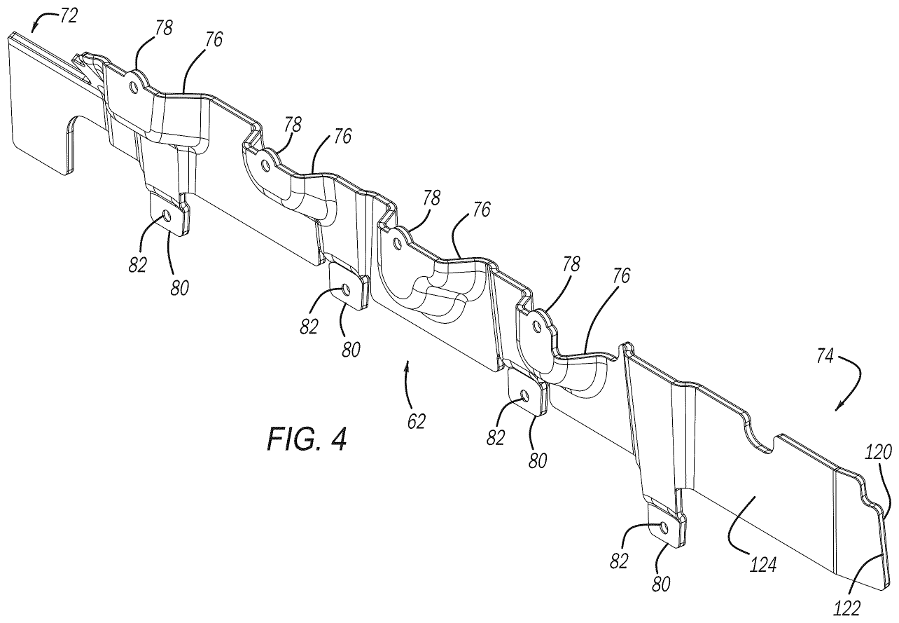

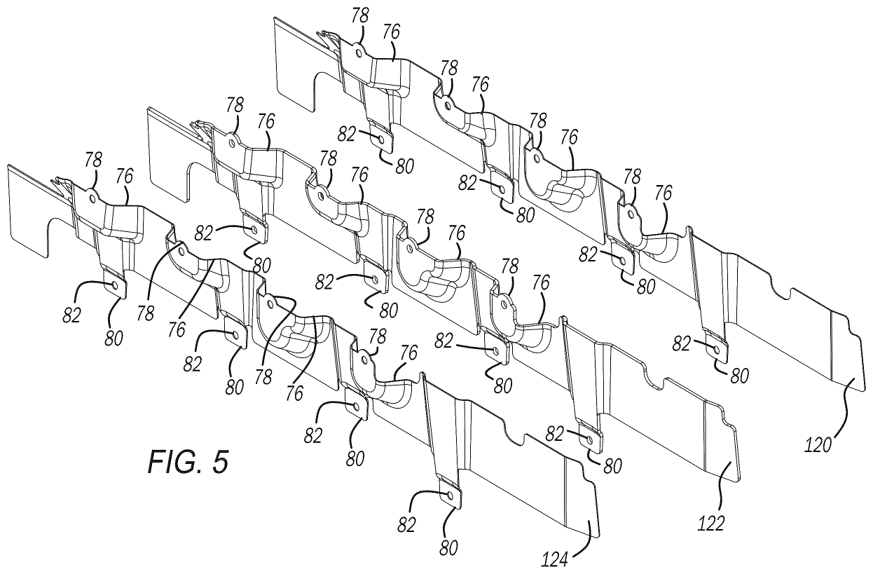

Turning now to FIGS. 4 and 5, it can be seen that the panels of the thermal shield assembly 26 include a multi-layered construction. While FIGS. 4 and 5 only illustrate center panel 62, it should be understood that each of the panels 62, 64, 66, 68, and 70 include the same construction. As shown in FIGS. 4 and 5, each panel 62-70 is comprised of a first layer 120, a second layer 122, and a third layer 124. The first layer 120 is configured to face or abut against the outer geometry of housing 28, and may be formed of aluminum or another rigid metal material. The first layer 114 may be between about 0.5 to about 1.0 mm in thickness, but is preferably about 0.7 mm in thickness. The first layer 114 is configured to reflect heat back in the direction of the battery 18 so as to prevent high temperatures from reaching components located proximate battery 18 and the passenger cabin 16 during a thermal runaway event.

The second layer 122 is sandwiched between first layer 120 and third layer 124, may be formed of fiberglass or another type of insulation material. A thickness of second layer 122 may be between about 1.0 to about 2.5 mm in thickness, but is preferably about 1.9 mm in thickness. The second layer 122 is configured to absorb heat that has not been reflected by the first layer 120.

The third layer 124 is configured to rest overtop the second layer 122, and faces outward from battery 18 such that third layer 124 is positioned nearest the components located proximate battery 18. Similar to first layer 120, the third layer 124 may be formed of aluminum or another rigid metal material. The third layer 124 may have the same thickness as first layer 120, or may have a greater or lesser thickness, and is configured to reflect heat that has not been absorbed by second layer 122 back towards the second layer 122 and battery 18. As shown in FIG. 5, each layer 122-124 is cut to have the same or substantially similar geometry such that the three layers 120, 122, 124 mate together to form a single contiguous panel 62. Arranged together, the panels 62-70 of thermal shield assembly 26 are configured to resist temperatures of up to 550° C., thereby protecting the components located proximate battery 18 from being damaged until five minutes post-battery failure, and potentially igniting until at least ten minutes post-battery failure.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A vehicle comprising:
a battery including a housing having at least a front housing wall and a pair of side housing walls attached to the front housing wall; and
a thermal shield assembly attached to the front housing wall and the pair of side housing walls,
wherein the thermal shield assembly is formed of a plurality of panels that are connected to each other,
each of the plurality of panels includes a first layer that faces the housing, a second layer attached to the first layer, and a third layer that sandwiches the second layer with the first layer and faces away from the housing, and
wherein the thermal shield assembly is configured to insulate the battery, and absorb and reflect heat generated by the battery back toward the battery.

2. The vehicle of claim 1, wherein the first and third layers are formed of a rigid metal material.

3. The vehicle of claim 2, wherein the second layer is formed of an insulating material.

4. The vehicle according to claim 2, wherein the first and third layers are formed of aluminum.

5. The vehicle according to claim 3, wherein the second layer includes fiberglass.

6. The vehicle of claim 1, wherein the first and third layers have a thickness that ranges between 0.5 to 1.0 mm.

7. The vehicle of claim 1, wherein the second layer has a thickness that ranges between 1.0 to 2.5 mm.

8. The vehicle of claim 1, wherein the plurality of panels includes a center panel, a first laterally offset panel attached to the center panel, a second laterally offset panel attached to the center panel, a first side panel attached to the first laterally offset panel, and a second side panel attached to the second laterally offset panel.

9. A thermal shield assembly configured to provide thermal shielding for a vehicle battery, the thermal shield assembly comprising:
a plurality of panels configured to be attached to the vehicle battery and collectively forming a thermal shield, the plurality of panels including a center panel, a first laterally offset panel attached to the center panel, a second laterally offset panel attached to the center panel, a first side panel attached to the first laterally offset panel, and a second side panel attached to the second laterally offset panel;
wherein each of the plurality of panels includes a first layer, a second layer, and a third layer, and
wherein the first layer and third layer are formed of a rigid metal material and the second layer is formed of an insulative material and is configured to be sandwiched between the first layer and the third layer.

10. The assembly of claim 9, wherein the vehicle battery includes a housing having at least a front housing wall and a pair of side housing walls attached to the front housing wall,
each of the center panel, the first laterally offset panel, and the second laterally offset panel are configured to be attached to the front housing wall, and
the first side panel and the second side panel are configured to be attached to a respective side housing wall.

11. The assembly of claim 10, wherein the thermal shield is configured to insulate the vehicle battery and absorb and reflect heat generated by the battery back toward the battery.

12. The assembly of claim 11, wherein the first layer is configured to face the housing.

13. The assembly of claim 12, wherein the first layer and the third layer are formed of aluminum.

14. The assembly of claim 13, wherein the first layer and the third layer each have a thickness that ranges between 0.5 to 1.0mm.

15. The assembly of claim 14, wherein the second layer includes fiberglass.

16. The assembly of claim 15, wherein the second layer has a thickness that ranges between 1.0 to 2.5mm.
